(19) United States
(12) Patent Application Publication
(10) Pub. No.: US 2004/0075741 A1
(43) Pub. Date: Apr. 22, 2004

(54) Multiple camera image multiplexer

(76) Inventors: Thomas F. Berkey, Coral Springs, FL (US); Daniel P. Fuoco, Boca Raton, FL (US)

Correspondence Address: Rick F. Comoglio, Sensormatic Electronics Corporation, 6600 Congress Avenue, Boca Raton, FL, 33487, US

(21) Appl. No.: 10/273,095

(22) Filed: Oct. 17, 2002

(51) Int. Cl. H04N 7/18; H04N 7/01

(52) U.S. Cl. 348/159; 348/441

(57) ABSTRACT

A multiple image video surveillance camera system that uses a common set of sequencing logic to sample multiple imaging devices or multiple pre-set image windows within a large high-resolution imaging device is provided. The images are multiplexed into a single frame or switched on a frame-by-frame basis at the imaging device. The switched frames are marked or encoded to facilitate separation for individual image display. This configuration allows one camera processor or sequencer to support multiple imagers and eliminates the need for a separate multiplexer, which lowers the system cost. Using a single transmission media to the video recording or display devices significantly reduces system installation cost.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates to multiple video camera image multiplexing and more particularly to using common sequencing logic to sample multiple imaging devices in a multi-camera system that is physically remote from display and recording of the images.

2. Description of the Related Art

Video surveillance systems have become so cost competitive that the installation cost will soon be much more than the equipment cost for the system. Multiple cameras mounted in a local area can be combined over a single cable to reduce the number of cables needed to run to a security room. Multiplexing video signals from multiple cameras over a common cable is a desirable solution. Two common ways this can be done are by tiling reduced images on each field, or by time slicing the image streams. Both methods require digitizing and buffering at least one frame of each image. Tiling requires additional processing to reduce the size of each image. Time multiplexing requires equipment to both multiplex and de-multiplex the combined image streams before viewing.

Currently, there are products on the market that combine multiple video images into a single image for display on a single monitor or for recording by a single VCR. They usually combine a selected number, such as 4, 9, 16, or the like, equal sized but reduced resolution images. Some products combine a medium sized image surrounded on sides by smaller images. The image sizes and formats can be dynamically changed on some products. In low-cost multiplexers, the images are updated at a rate of one image per frame, such that none of the images are updated at a standard 30 Hz rate.

Other products combine video camera inputs by switching between multiple images on a frame-by-frame basis, marking each frame in the vertical retrace interval with a pre-determined source number. The combined image stream can be fed directly to VCRs, but must be de-multiplexed for display. The video inputs encoded by this type of multiplexer can have the maximum resolution for each image. For implementing a frame-by-frame switched approach, a de-multiplexer is required for displaying, and the images are not updated at the full 30 Hz frame rate required for full motion video. The more image sources that are multiplexed, the slower the frame rate for each.

For implementing multiple tiled images on a frame approach, the resolution of the images will be reduced inversely-proportional to the number displayed on each frame, unless the image source has a lower resolution than the maximum possible for the format being used. For example, four national television system committee (NTSC) resolution images would need to be multiplexed in high definition television (HDTV) format to have no perceivable loss.

Referring to FIG. 1, a conventional four-camera system is illustrated, and which could be illustrated with fewer or additional cameras, each camera illustrated being identical to each other, and each additional camera being similar to those illustrated. Current multi-head cameras 2 use a complete set of electronics for each camera. Video cameras typically include a lens assembly 4 to focus light from an image onto a photosensitive CCD or CMOS array that is mounted on imager 6. A good quality video-imaging array consists of a matrix of photosensitive cells configured as about 500 lines with about 800 photosensitive cells per line. The arrays are designed to accumulate light for typically up to 1/60^{th} of a second. The accumulated analog values are then shifted out of the imager 6, line by line under control of a sequencer circuit 8. The analog levels are sampled by an analog-to-digital converter located on imager 6, and passed on as a digitized image to encoder 9 for conversion to a suitable video format, such as NTSC, phase alternating line (PAL), or “sequential couleur avec memoire” (sequential color with memory) (SECAM) video signal. Alternately, the analog levels are amplified and inserted directly into one of the suitable video formats. The sequencing circuit 8 is typically implemented with a small ASIC, CPLD, FPGA, DSP, or the like.

If multiple image streams are reduced and combined for transmission over a single medium, an external multiplexer 10 is used to decode, at decoder 12, the analog video image into a digital data stream to frame buffer 16 under control of sequencer 14, according to the format information from decoder 12. Buffered data from frame buffer 16 is re-sampled, synchronized, and combined into image frames at quad sequencer 18, before encoding the combined video images into a suitable video format at encoder 20. Typically, the image fields can be reduced in size by either averaging (or discarding) pixels or lines of pixels. In the case of a frame-by-frame switched multiplexer, whole frames of data are discarded while other video sources are being transmitted. The cost of the image digitizing, processing and encoding equipment required to multiplex and de-multiplex multiple image streams offsets most of the savings obtained by reducing the number of cables. A lower cost method is desirable for obtaining multiple video image streams from surveillance cameras to backroom viewing and recording equipment.

### BRIEF SUMMARY OF THE INVENTION

The invention is a multiple image video camera system delivering a single video stream, and includes the following. A plurality of imaging devices, each having a lens assembly and corresponding imager for converting light to an electrical signal, the electrical signal representing at least a portion of an image. A sequencer for receiving the electrical signal from each of the imaging devices, the sequencer controls synchronization for each of the images. The sequencer includes multiplexing each of the signals in a preselected configuration to form the single video stream. The sequencer and multiplexer are integrated together substantially as a single unit.

The system may include a plurality of line buffers for receiving each of the electrical signals from each of the plurality of imaging devices, the line buffer temporarily stores at least a portion of the electrical signal. The sequencer receives the electrical signal from each of the plurality of line buffers. The plurality of line buffers are integrated together with the sequencer and multiplexer substantially as a single unit.

The system may further include an encoder for coding the single video stream into a preselected video format. The electrical signal and the single video stream can be digital signals, and the preselected video format can be an analog signal. The selected video format can be a common format such as NTSC, PAL, SECAM, or HDTV.

The preselected configuration forming the single video stream can be selected as a tiled or time-multiplexed configuration of the image from each of the plurality of imaging devices, or the configuration can be a single image from one of the imaging devices. The tiled configuration requires inclusion of the plurality of line buffers.

Objectives, advantages, and applications of the present invention will be made apparent by the following detailed description of embodiments of the invention.

### BRIEF DESCRIPTION OF THE SEVERAL VIEWS OF THE DRAWINGS

FIG. 1 is a block diagram of a conventional multi-camera image multiplexed system.

FIG. 2 is a block diagram of one embodiment of the present invention.

### DETAILED DESCRIPTION OF THE INVENTION

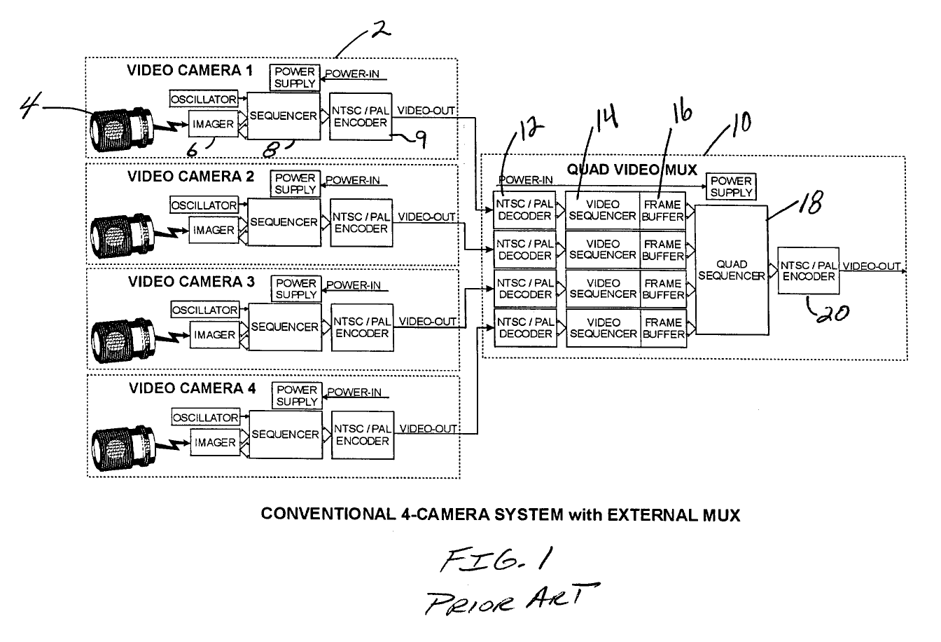

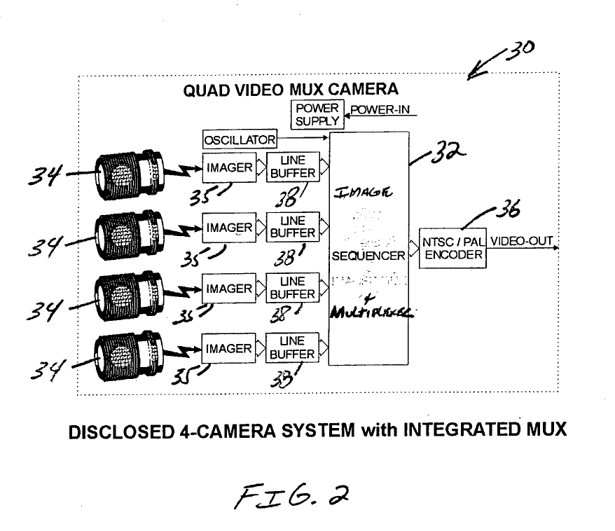

Referring to FIG. 2, the present invention is illustrated with a four-camera system example to directly compare with the prior art four-camera system example illustrated in FIG. 1. It should be understood that the invention is not limited to a four camera system, and can include additional or fewer cameras. Multiple camera image multiplexer system 30 is a single unit that can be housed in a single enclosure and uses a single set of image sequencing and multiplexing logic 32 to sample multiple imaging devices 34, which can be mounted in a local array. Any technology sensor, including CCD or CMOS and others, can be used. Image sequencer and multiplexer 32 combines the video signals from each sensor 34 and imager 35 into a single video stream before encoding as NTSC, PAL, SECAM, HDTV, or other video format, at encoder 36. Image multiplexer 30 can be commanded to switch between various tiled, time-multiplexed or single image output configurations. The images from imager 35 are fed into common sequencing logic, a line buffer 38 can be used to help sequence the images for the tiled mode instead of using a frame buffer 16 as required in the prior art system, illustrated in FIG. 1.

Multiple image windows from one or more high-resolution imagers 35 can be switched on a frame-by-frame basis and/or time-multiplexed over lower resolution transmission formats, and fed to a standard resolution recorder and/or display. Optionally, image sequencer and multiplexer 32, with additional buffer memory storage space, can provide motion detection locally on the output of each imager 35. The imaging sensors 34 can be fixed mount or gimbaled, and may be color or black and white, and have fixed or adjustable zoom, focus, and exposure. Remote control of these functions can be sent up a single cable, such as a video coax or twisted pair, to image sequencer and multiplexer 32, or commands can be sent manually or over a local area network directly to sequencer and multiplexer 32. Motion detection alarms and selected highlighted image data can also be transmitted, if desired.

The present invention significantly reduces the cost of a multi-camera cluster by eliminating duplicated image sampling circuits for each imager, and integrating the image sequencer and multiplexer 32 in the multi-head imaging unit 30. As shown in FIG. 1, sequencer 8, encoder 9, decoder 12, sequencer 14, and quad sequencer 18 are replaced by common image sequencer and multiplexer 32, shown in FIG. 2. In addition, local image sequencer and multiplexer 32 is simpler than an external device 10, shown in FIG. 1, because the image streams do not have to be individually buffered at frame buffer 16 to synchronize the frames for quad sequencer 18, frame buffer 16 is replaced by a simpler and less expensive line buffer 38. Tile multiplexed images can be displayed simultaneously on the same display at a full 30 Hz frame rate. If the tile multiplexed video mode is not desired, line buffer 38 can be eliminated, and the data from imager 35 can be fed directly to image sequencer and multiplexer 32. The single sequencer and multiplexer 32 maintains synchronization on all of the imagers 35. Due to the reduction of encoders and decoders, and the resultant reduction in sampling and conversion errors, the combined video image output of sequencer and multiplexer 32 is a higher quality video signal than the combined image output of prior art multiplexer 10.

As a result of implementing the multiple camera image multiplexer system 30, multiple sets of video, control, and, optionally, power, can be transmitted over a single cable significantly reducing installation costs. Individual imaging heads 34 can be aimed to cover independent scenes such as entranceways, windows, checkout counters, cash registers and the like, or can be mounted with overlapping fields of view to provide 360° coverage at a much lower cost than previously possible.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the forgoing disclosure.

What is claimed is:

1. A multiple image video camera system delivering a single video stream, comprising:
a plurality of imaging devices, each having a lens assembly and corresponding imager for converting light into an electrical signal, the electrical signal representing at least a portion of an image;
a sequencer for receiving the electrical signal from each of said plurality of imaging devices, said sequencer including means for synchronizing each of said images, said sequencer further including multiplexer means for combining each of said signals in a preselected configuration forming said single video stream; and,
wherein said sequencer and said multiplexer means being integrated together substantially as a single unit.

2. The system of claim 1 further comprising:
a plurality of line buffers for receiving one each of the electrical signal from each of said plurality of imaging devices, said line buffer temporarily storing at least a portion of said electrical signal;
said sequencer for receiving the electrical signal from each of said plurality of line buffers, said sequencer including means for synchronizing each of said images, said sequencer further including multiplexer means for combining each of said signals in a preselected configuration forming said single video stream; and,
wherein said plurality of line buffers, said sequencer and said multiplexer means being integrated together substantially as a single unit.

3. The system of claim 2 further comprising an encoder for coding said single video stream into a preselected video format.

4. The system of claim 3 wherein said electrical signal and said single video stream are digital signals, and said preselected video format is an analog signal.

5. The system of claim 3 wherein said preselected video format is NTSC, PAL, SECAM, or HDTV.

6. The system of claim 2 wherein said preselected configuration forming said single video stream comprises a tiled configuration of the image from each of said plurality of imaging devices.

7. The system of claim 1 wherein said preselected configuration forming said single video stream comprises a time-multiplexed configuration of the image from each of said plurality of imaging devices.

8. The system of claim 2 wherein said preselected configuration forming said single video stream comprises a time-multiplexed configuration of the image from each of said plurality of imaging devices.

9. The system of claim 1 wherein said preselected configuration forming said single video stream comprises a single image from one of said plurality of imaging devices.

10. The system of claim 2 wherein said preselected configuration forming said single video stream comprises a single image from one of said plurality of imaging devices.

11. The system of claim 2 wherein said plurality of image devices, said plurality of line buffers, said sequencer, and said multiplexer means being integrated together substantially as a single unit.
